(19) United States
(12) Patent Application Publication
(10) Pub. No.: US 2023/0229042 A1
(43) Pub. Date: Jul. 20, 2023

(54) LIQUID CRYSTAL DEVICES COMPRISING INTERDIGITATED ELECTRODES

(71) Applicant: CORNING INCORPORATED, CORNING, NY (US)

(72) Inventors: Douglas Llewellyn Butler, Painted Post, NY (US); Andrii Varanytsia, Sunnyvale, CA (US)

(21) Appl. No.: 18/010,062

(22) PCT Filed: Jun. 25, 2021
(86) PCT No.: PCT/US2021/039055

§ 371 Date: Dec. 13, 2022

Related U.S. Application Data
(60) Provisional application No. 63/046,963, filed on Jul. 1, 2020.
(60) Provisional application No. 63/051,104, filed on Jul. 13, 2020.

(51) Int. Cl. G02F 1/1343; G02F 1/1337

(52) U.S. Cl. CPC G02F 1/134363; G02F 1/133784

(57) ABSTRACT

Disclosed are liquid crystal devices comprising multiple interdigitated electrodes and at least one liquid crystal layer. Also disclosed are liquid crystal devices comprising at least three interdigitated electrodes.

### CROSS-REFERENCE TO RELATED APPLICATIONS

This application claims the benefit of priority under 35 U.S.C. § 371 of International Application No. PCT/US2021/039055, filed on Jun. 25, 2021, which claims the benefit of priority under 35 U.S.C. § 119 of U.S. Provisional Application No. 63/046,963 filed Jul. 1, 2020, and claims the benefit of priority under 35 U.S.C. § 119 of U.S. Provisional Application No. 63/051104, filed Jul. 13, 2020, the content of each of which is incorporated herein by reference in its entirety.

### FIELD OF THE DISCLOSURE

The disclosure relates generally to liquid crystal devices comprising an electrode assembly including multiple interdigitated electrodes and at least one liquid crystal layer, and more particularly to liquid crystal devices utilizing in-plane switching and comprising at least three interdigitated electrodes.

### BACKGROUND

Liquid crystal devices are used in various architectural and transportation applications, such as windows, doors, space partitions, and skylights for buildings and automobiles. For many commercial applications, it is desirable for liquid crystal devices to provide high transmission in the bright state and high contrast ratio between the on and off states while also providing good energy efficiency and cost effectiveness. In the case of liquid crystal windows, it is desirable to decrease optical losses as much as possible in the bright state to maximize the amount of light that enters through the window. Additionally, to achieve a high contrast ratio, the window should attenuate as much of the incident light as possible in the dark state.

Liquid crystal devices utilizing interdigitated electrodes, such as an in-plane switching (IPS) electrode pattern, can provide an attractive low-cost design because they require electrode placement on only one of the two substrates making up the liquid crystal cell. However, conventional interdigitated electrode design for IPS can produce “dead zones” or areas of the liquid crystal cell that are not switched or not fully switched between the bright and dark states, thus lowering the overall contrast ratio. In some instances, as much as 5 to 20% of the liquid crystal molecules may not switch in a typical IPS design, which can lead to light leakage in the dark state and, by extension, a lower contrast ratio for the overall device.

As such, there is a need for liquid crystal devices utilizing interdigitated electrodes that have fewer or no “dead zones.” It would also be advantageous to provide such a liquid crystal device with reduced manufacturing complexity and/or cost. It would further be advantageous to improve the light transmittance in the bright state and the contrast ratio between the bright and dark states for such a liquid crystal device.

### SUMMARY

The disclosure relates, in various embodiments, to liquid crystal devices comprising: a first substrate comprising an outer surface and an interior surface; a second substrate comprising an outer surface and an interior surface; a liquid crystal layer comprising a first surface and a second surface, wherein the liquid crystal layer is disposed between the first substrate and the second substrate; and an electrode assembly comprising at least three interdigitated electrodes, wherein the electrode assembly is disposed on the interior surface of the first substrate. Also disclosed herein are liquid crystal windows comprising such a liquid crystal device and a glass substrate separated from the liquid crystal device by a sealed gap.

In non-limiting embodiments, the first and second substrates can be glass substrates. The interdigitated electrodes can comprise, in various embodiments, at least one transparent conductive layer, such as at least one transparent conductive oxide. According to certain embodiments, the electrode assembly can comprise more than two interdigitated electrodes, such as three interdigitated electrodes or four interdigitated electrodes. For instance, the electrode assembly can comprise a first electrode layer comprising a first interdigitated electrode and a second interdigitated electrode, a second electrode layer comprising a third interdigitated electrode, and a passivation layer disposed between the first and second electrode layers. Alternatively, the electrode assembly can comprise a first electrode layer comprising a first interdigitated electrode and a second interdigitated electrode, a second electrode layer comprising a third interdigitated electrode and a fourth interdigitated electrode, and a passivation layer disposed between the first and second electrode layers. The passivation layer can comprise, by way of non-limiting example, SiN or SiO₂. In additional embodiments, the electrode assembly can comprise a first pair of interdigitated electrodes having a first period and a second pair of interdigitated electrodes having a second period, wherein the first period is longer than the second period.

According to certain embodiments, the liquid crystal device can further comprise at least one alignment layer in direct contact with the first or second surface of the liquid crystal layer. A first alignment layer may be in direct contact with the first surface of the liquid crystal layer and a second alignment layer may be in direct contact with the second surface of the liquid crystal layer. In various embodiments, the liquid crystal layer can further comprise at least one additional component chosen from dyes, coloring agents, chiral dopants, polymerizable reactive monomers, photoinitiators, and polymerized structures. According to additional embodiments, a liquid crystal device of comprises a twisted supramolecular structure.

In further embodiments, the first alignment layer can have a first rubbing direction and the second alignment layer can have a second rubbing direction, wherein the first and second rubbing directions are orthogonal to one another. According to still further embodiments, the liquid crystal device can comprise a second electrode assembly disposed on the interior surface of the second substrate. The first electrode assembly comprises a first electrode direction and the second electrode assembly comprises a second electrode direction, and the first and second electrode directions can be orthogonal to one another. A first rubbing direction of the first alignment layer can be orthogonal to the first electrode direction, and a second rubbing direction of the second alignment layer can be orthogonal to the second electrode direction.

Further disclosed herein are liquid crystal devices comprising: a first substrate comprising an outer surface and an interior surface; a second substrate comprising an outer surface and an interior surface; a third substrate comprising a first interior surface and a second interior surface, wherein the third substrate is disposed between the first and second substrates; a first liquid crystal layer disposed between the first substrate and the third substrate; a second liquid crystal layer disposed between the second substrate and the third substrate; a first electrode assembly comprising at least three interdigitated electrodes, wherein the first electrode assembly is disposed on the interior surface of the first substrate or the first interior surface of the third substrate; and a second electrode assembly comprising at least three interdigitated electrodes, wherein the first electrode assembly is disposed on the interior surface of the second substrate or the second interior surface of the third substrate. Still further disclosed herein are liquid crystal windows comprising such a liquid crystal device and a glass substrate separated from the liquid crystal device by a sealed gap.

In certain embodiments, the first and second substrate can be glass substrates and the third substrate can be chosen from glass, plastic, and glass ceramic substrates. The interdigitated electrodes of the first and/or second electrode assemblies can, for example, comprise at least one transparent conductive oxide. According to certain embodiments, the first and/or second electrode assembly can comprise more than two interdigitated electrodes, such as three interdigitated electrodes or four interdigitated electrodes. The first and/or second liquid crystal layers can comprise a twisted supramolecular structure or a nematic structure. In certain embodiments, a first electrode direction of the first electrode assembly can be orthogonal to a second electrode direction of the second electrode assembly.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework for understanding the nature and character of the claims. The accompanying drawings are included to provide a further understanding of the disclosure and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1A depicts a top view of a pair of interdigitated electrodes for a prior art liquid crystal device;

FIG. 1B depicts the equipotential lines created by a prior art interdigitated electrode pair;

FIG. 2A depicts liquid crystal director orientation at low voltage for a prior art liquid crystal device comprising interdigitated electrodes;

FIG. 2B depicts liquid crystal director orientation at high voltage for a prior art liquid crystal device comprising interdigitated electrodes;

FIG. 3A depicts a top view of an electrode assembly comprising four interdigitated electrodes according to various embodiments of the disclosure;

FIG. 3B depicts a top view of the first pair of interdigitated electrodes of FIG. 3A and the first horizontal liquid crystal director regions created by these electrodes;

FIG. 3C depicts a top view of the second pair of interdigitated electrodes of FIG. 3A superimposed over the first horizontal liquid crystal director regions;

FIG. 3D depicts a top view of the second pair of interdigitated electrodes of FIG. 3A and the second horizontal liquid crystal director regions created by these electrodes;

FIG. 3E depicts a top view of the first and second horizontal liquid crystal director regions created by both pairs of the interdigitated electrodes in FIG. 3A (electrodes not depicted);

FIG. 4 depicts a top view of an electrode assembly comprising three interdigitated electrodes according to certain embodiments of the disclosure;

FIG. 5A depicts a top view of an electrode assembly comprising four interdigitated electrodes with a first pair of electrodes having a long period and a second pair of electrodes having a narrow period according to additional embodiments of the disclosure;

FIG. 5B depicts the horizontal liquid crystal director region created by the first pair of interdigitated electrodes;

FIG. 6 depicts a cross sectional view of a liquid crystal device comprising an interdigitated electrode assembly and a single liquid crystal layer according to various embodiments of the disclosure;

FIG. 7 depicts a cross sectional view of a liquid crystal device comprising two interdigitated electrode assemblies and two liquid crystal layers according to additional embodiments of the disclosure;

FIGS. 8A-B depict an exploded view of a liquid crystal device comprising a single liquid crystal layer with a twisted structure and orthogonally oriented alignment layers in the bright and dark states, respectively; and

FIGS. 9A-B depict an exploded view of a liquid crystal device comprising a single liquid crystal layer with a twisted structure and orthogonally oriented electrode layers in the bright and dark states, respectively.

### DETAILED DESCRIPTION

Disclosed herein are liquid crystal devices comprising: a first substrate comprising an outer surface and an interior surface; a second substrate comprising an outer surface and an interior surface; a liquid crystal layer comprising a first surface and a second surface, wherein the liquid crystal layer is disposed between the first substrate and the second substrate; and an electrode assembly comprising at least three interdigitated electrodes, wherein the electrode assembly is disposed on the interior surface of the first substrate. Also disclosed herein are liquid crystal windows comprising such a liquid crystal device and a glass substrate separated from the liquid crystal device by a sealed gap.

Also disclosed herein are liquid crystal devices comprising: a first substrate comprising an outer surface and an interior surface; a second substrate comprising an outer surface and an interior surface; a third substrate comprising a first interior surface and a second interior surface, wherein the third substrate is disposed between the first and second substrates; a first liquid crystal layer disposed between the first substrate and the third substrate; a second liquid crystal layer disposed between the second substrate and the third substrate; a first electrode assembly comprising at least three interdigitated electrodes, wherein the first electrode assembly is disposed on the interior surface of the first substrate or the first interior surface of the third substrate; and a second electrode assembly comprising at least three interdigitated electrodes, wherein the first electrode assembly is disposed on the interior surface of the second substrate or the second interior surface of the third substrate. Further disclosed herein are liquid crystal windows comprising any liquid crystal device disclosed herein and a glass substrate separated from the liquid crystal device by a sealed gap.

### Interdigitated Electrodes

### Two-Electrode Design

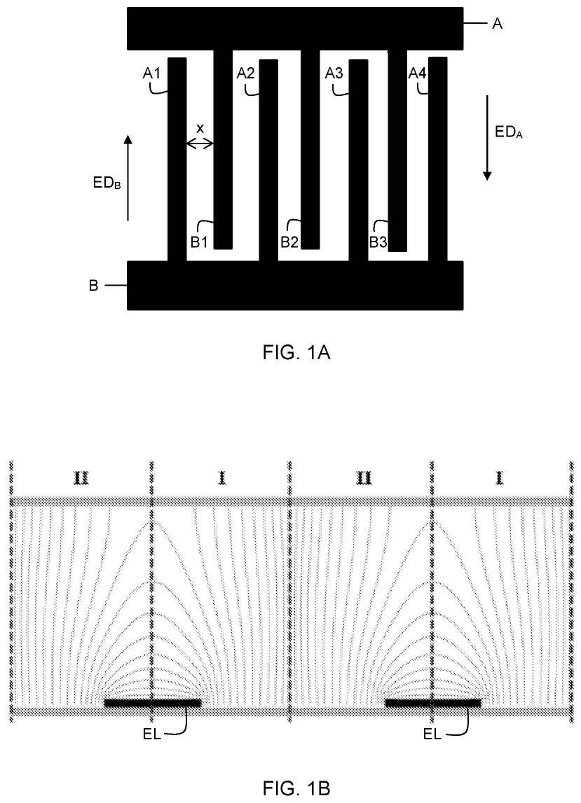

Conventional interdigitated electrodes comprise two coplanar electrodes patterned on a single surface of one of the substrates defining, i.e., confining, a liquid crystal layer. Liquid crystal layer(s) can be controlled by interdigitated electrodes, in which an electric field starts at a higher voltage interdigitated electrode, travels through any surrounding media (such as an adjacent liquid crystal layer), and terminates at a lower voltage interdigitated electrode. A typical interdigitated electrode design comprising two coplanar electrodes is shown in FIG. 1A. Electrodes A and B comprise segments A1, A2, A3, A4 and B1, B2, and B3, respectively, that extend toward each other in directions EDA, EDB, respectively, to form an interlocking pattern. Electrodes A and B and their respective segments are proximate to one another but do not touch. Each A segment can be spaced apart from the adjacent B segment by a gap x, which can vary depending on cell design. Typically, in order to minimize the size of dead zones above each electrode segment, the width of each segments is chosen to be smaller than the width of the gap x between segments. For example, the electrode segments can have a width ranging from about 1 μm to about 20 μm and the gaps between adjacent electrode segments can have a width ranging from about 3 μm to about 100 μm.

During operation, voltage is applied across the gaps x between alternate electrode segments, producing the equipotential lines shown in FIG. 1B, which is reproduced from Choi et al., “Electro-optical characteristics of an in-plane switching liquid crystal cell with zero rubbing angle: dependence on the electrode structure,” Optics Express, vol. 24, iss. 14, pp. 15987-15996 (2016). The closer the equipotential lines are, the stronger the electric field. The orientation of liquid crystal material can be described by a unit vector, referred to herein as a “director,” which represents the average local orientation of the long molecular axes of the liquid crystal molecules. Over the electrodes EL the equipotential lines are farther apart and oriented horizontally, which tends to reduce how strongly the liquid crystal directors are rotated away from vertical in those regions.

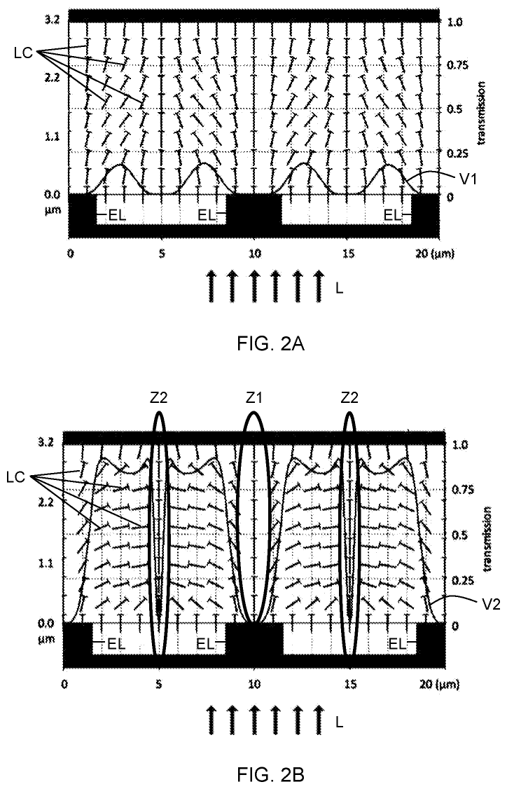

Referring to FIGS. 2A-B, which are reproduced from Weng et al., “High-efficiency and fast-switching field-induced tunable phase grating using polymer-stabilized in-plane switching liquid crystals with vertical alignment,” J. Physics D: Applied Physics, vol. 49, no. 12, pp. 1-7 (2016), the liquid crystal director LC orientation is illustrated for a typical liquid crystal cell with interdigitated electrodes and vertical alignment. The voltage-induced deformation profile of LC directors is represented by curves V1 (low voltage), V2 (high voltage), respectively. In the powered off state, it is desirable to have a liquid crystal director orientation in a minimally attenuating state. FIG. 2A shows the liquid crystal directors LC aligned nearly vertically at lower voltage V1, allowing light L to propagate through the liquid crystal cell with relatively low optical losses in a bright state. In the powered on state, the desired effect is to change the liquid crystal director orientation into a maximally absorbing state, i.e., a horizontal orientation that attenuates light L to produce a dark state.

However, it can be seen from FIG. 2B that the liquid crystal cell has inactive areas or “dead zones” where the applied voltage V2 does not adequately reorient the liquid crystal cells, thereby allowing light leakage in an otherwise dark state. Liquid crystals directly above each of the electrodes EL do not get rotated during the electrical cycle and remain vertical, resulting in dead zone(s) Z1. Additional dead zone(s) Z2 may exist in smaller regions directly in between electrodes EL. Because the liquid crystal molecules are not reoriented, optical transmission in the dead zones Z1, Z2 is not affected by the applied voltage V2.

For liquid crystal windows that are bright in the off state (as illustrated in FIGS. 2A-B), the contrast ratio for the overall liquid crystal device is degraded by the dead zones Z1, Z2. As shown in FIG. 2B, the liquid crystal directors LC are in a highly attenuating state except in dead zones Z1, Z2, which leads to overall reduced light attenuation and can, in some instances, produce bright and dark regions or stripes that may be visible to the end user. For liquid crystal windows that are dark in the off state (not illustrated), the dead zones Z1, Z2 result in optical losses of the incident light, which leads to a degraded bright state.

### Multi-Electrode Design

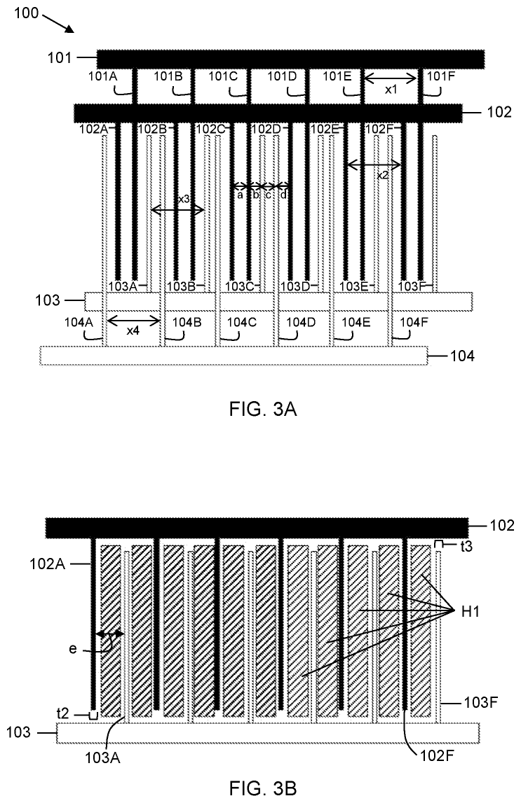

The instant disclosure relates to a liquid crystal device with a non-standard electrode design, i.e., comprising more than two interdigitated electrodes. Multi-electrode assemblies as referred to herein comprise three or more interdigitated electrodes, such as four or more, five or more, or six or more electrodes. Embodiments of the disclosure will now be discussed with reference to FIGS. 3-5, which illustrate interdigitated electrode assemblies according to various embodiments of the disclosure. The following general description is intended to provide an overview of the claimed devices, and various aspects will be more specifically discussed throughout the disclosure with reference to the non-limiting depicted embodiments, these embodiments being interchangeable with one another within the context of the disclosure.

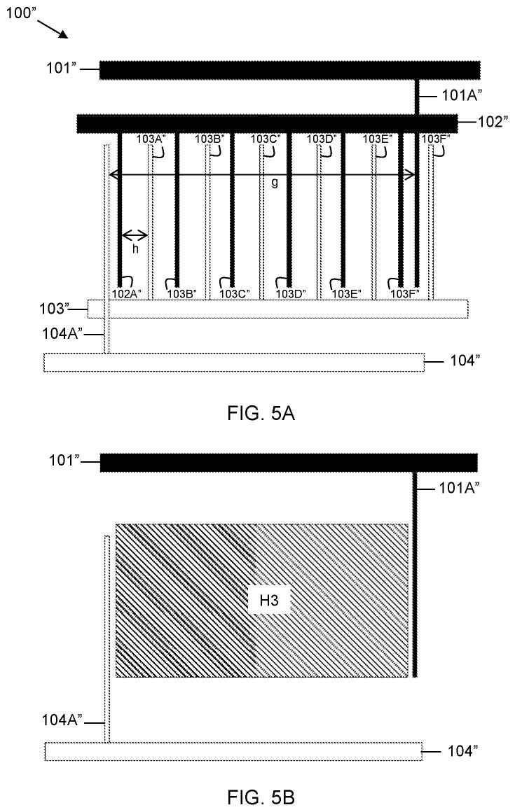

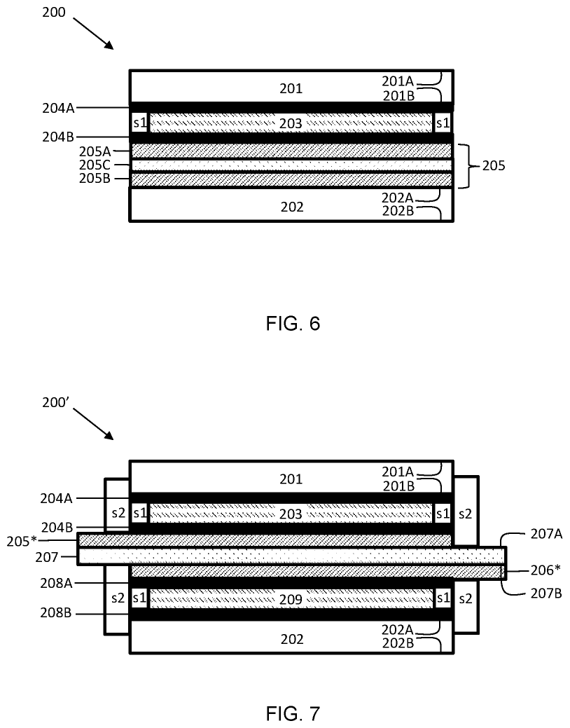

FIG. 3A illustrates a non-limiting embodiment of a multi-electrode design for a liquid crystal device with interdigitated electrodes. The interdigitated electrode assembly 100 comprises four electrodes 101, 102, 103, 104. First electrode 101 and fourth electrode 104 can form a first interdigitated pair that can be connected to a first power supply (not shown) and second electrode 102 and third electrode 103 form a second interdigitated pair that can be connected to a second power supply (not shown). Electrodes 101 and 104 can be coplanar in a first electrode layer and electrodes 102 and 103 can be coplanar in a second electrode layer, and these electrode layers can be separated by a barrier or passivation layer as depicted in FIGS. 6-7, discussed in more detail below. Other electrode layer orientations, electrode pairings, and/or power supply connections are also possible and intended to fall within the scope of the disclosure.

Referring again to FIG. 3A, third and fourth electrodes 103 and 104 can be interdigitated between first and second electrodes 101 and 102, and vice versa. For example, electrode segments 101A and 102A are both located between electrode segments 103A and 104A, and so forth. Similarly, electrode segments 103A and 104B are both located between electrode segments 101A and 102B, and so forth. As depicted in FIG. 3A, the two pairs of interdigitated electrode can comprise a repeating electrode segment pattern as follows: [[-101-103-104-102-]]; however any repeating segment pattern is possible and intended to fall within the scope of the disclosure.

Each of the electrode segments in a single electrode can be separated by gaps having the same or different widths. For example, a gap x1 between first electrode 101 segments, e.g., segments 101A-F, such as the distance between segments 101A and 101B, can range from about 10 μm to about 200 μm, from about 20 μm to about 100 μm, or from about 30 μm to about 50 μm, including all ranges and subranges therebetween. Similarly, a gap x2 between second electrode 102 segments, e.g., segments 102A-F, such as the distance between segments 102A and 102B, can be independently chosen from the ranges give above for gap x1. A gap x3 between third electrode 103 segments, e.g., segments 103A-F, such as the distance between segments 103A and 103B, can be independently chosen from the ranges give above for gap x1. Finally, a gap x4 between fourth electrode 104 segments, e.g., segments 104A-F, such as the distance between segments 104A and 104B, can be independently chosen from the ranges give above for gap x1.

Adjacent electrode segments from different electrodes can also be separated by gaps having the same or different widths. For example, gap a between adjacent segments of first and second electrodes 101, 102, such as segments 101C and 102C, can range from about 3 μm to about 100 μm, from about 5 μm to about 50 μm, or from about 10 μm to about 25 μm, including all ranges and subranges therebetween. Similarly, a gap b between adjacent segments of first and third electrodes 101, 103, such as segments 101C and 103C, can be independently chosen from the ranges give above for gap a. A gap c between adjacent segments of third and fourth electrodes 103, 104, such as segments 103C and 104D, can be independently chosen from the ranges give above for gap a. Finally, a gap d between segments of fourth and second electrodes 104, 102, such as segments 104D and 102D, can be independently chosen from the ranges give above for gap a.

FIG. 3B illustrates second and third electrodes 102, 103 and their interdigitated segments 102A-F (A, F labeled; B-E not labeled), 103A-F (A, F labeled; B-E not labeled), as well as the horizontal liquid crystal director regions H1 created when voltage is applied across gaps e between the electrodes. A width of gap e can range, in some embodiments, from about 5 μm to about 200 μm, from about 10 μm to about 100 μm, or from about 20 μm to about 50 μm, including all ranges and subranges therebetween. A thickness t2 of one or more of the second electrode segments, e.g., electrode segment 102A, can range from about 3 μm to about 100 μm, from about 10 μm to about 50 μm, or from about 20 μm to about 30 μm, including all ranges and subranges therebetween. Similarly, a thickness t3 of one or more of the third electrode segments, e.g., electrode segment 103F, can be independently chosen from the ranges give above for thickness t2.

FIG. 3C illustrates first and fourth electrodes 101, 104 and their interdigitated segments 101A-F (A, F labeled; B-E not labeled), 104A-F (A, F labeled; B-E not labeled) interposed over the horizontal liquid crystal director regions H1 created when voltage is applied across second and third electrodes 102, 103. FIG. 3D illustrates first and fourth electrodes 101, 104 and their interdigitated segments 101A-F (A, F labeled; B-E not labeled), 104A-F (A, F labeled; B-E not labeled), as well as the horizontal liquid crystal director regions H2 created when voltage is applied across gaps f between the electrodes. A width of gap f can range, in some embodiments, from about 5 μm to about 200 μm, from about 10 μm to about 100 μm, or from about 20 μm to about 50 μm, including all ranges and subranges therebetween. A thickness t1 of one or more of the first electrode segments, e.g., electrode segment 101A, can range from about 3 μm to about 100 μm, from about 10 μm to about 50 μm, or from about 20 μm to about 30 μm, including all ranges and subranges therebetween. Similarly, a thickness t4 of one or more of the fourth electrode segments, e.g., electrode segment 104F, can be independently chosen from the ranges give above for thickness t1.

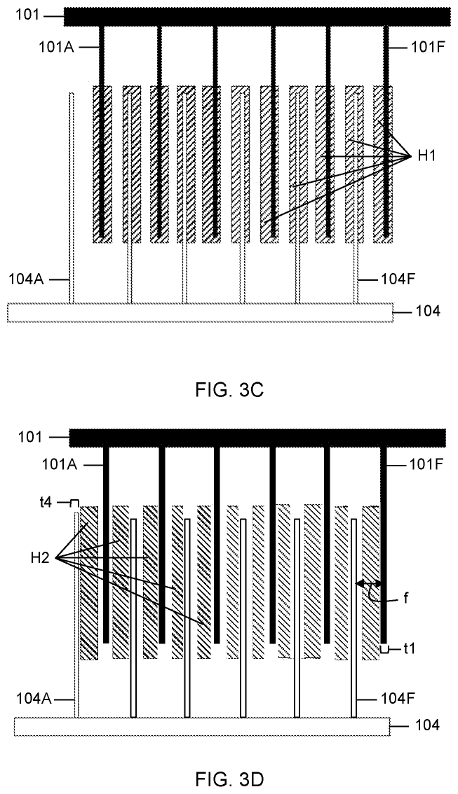

FIG. 3E illustrates the first horizontal liquid crystal director regions H1 created by the second and third interdigitated electrodes 102, 103 (not illustrated) and the second horizontal liquid crystal director regions H2 created by the first and fourth interdigitated electrodes 101, 104 (not illustrated). Full coverage of the liquid crystal cell (not illustrated) can be achieved because horizontal liquid crystal director regions H1, H2 abut or partially overlap, leaving no regions with vertically oriented liquid crystal directors. Attenuation over the entire liquid crystal cell should thus be substantially close to the ideal, maximum-attenuation state. Similar coverage can be obtained with more than four interdigitated electrodes, or even with three interdigitated electrodes, as illustrated in FIG. 4.

A key characteristic of liquid crystal cells is that when alternating voltage is applied to the cell, the liquid crystal molecules polarize and may not flip orientation direction when the polarity of the applied electric field reverses. If the liquid crystal molecules cannot be initially aligned into the desired orientation, then the application of an alternating voltage may not be effective for changing the original orientation. As such, according to various embodiments of the disclosure, a first voltage may be applied to drive all or nearly all of the liquid crystal molecules in a given liquid crystal layer into a desired rotated state (e.g., horizontal) for at least part of an electrical driving cycle, after which the orientation may be held or maintained by the application of alternating voltage throughout the remainder of the electrical cycle. In certain embodiments, the timing and voltage levels may be chosen to maintain the horizontal orientation of already horizontally oriented liquid crystal molecules throughout the full electrical cycle. In additional embodiments, the timing and voltage levels may be chosen to reorient vertically oriented molecules into a horizontal orientation for at least some of the time during the full electrical cycle. In further embodiments, an exemplary voltage sequence can have a first voltage sequence that orients the liquid crystal molecules into the horizontal orientation, followed by a second continuous voltage sequence that keeps the molecules aligned horizontally.

It should be noted that, while FIGS. 3A-E are discussed in the context of a liquid crystal device that produces a bright state when powered off (no applied voltage, V=0) and dark state when powered on (V≠0), a device operating with the reverse configuration is also possible and intended to fall within the scope of the disclosure.

FIG. 4 illustrates an additional embodiment of a multi-electrode design for an IPS liquid crystal device. The interdigitated electrode assembly 100′ comprises three electrodes 101′, 102′, 103′. One or more power supplies (not illustrated) can be connected to electrodes 101′, 102′ and 103′ to supply voltage to a desired electrode pair, such as a pair formed by first and second electrodes 101′, 102′, a pair formed by first and third electrodes 101′, 103′ and/or a pair formed by second and third electrodes 102′, 103′. As discussed in more detail below with respect to FIGS. 6-7, one or more of electrodes 101′, 102′, 103′ can be separated from the other electrode(s) by a barrier or passivation layer. For example, first and second interdigitated electrodes 101′, 102′ can be coplanar in a first electrode layer and the third interdigitated electrode 103′ can be in a second electrode layer, these electrode layers being separated by a passivation layer. Other electrode layer orientations, electrode pairings, and/or power supply connections are also possible and intended to fall within the scope of the disclosure.

Referring again to FIG. 4, first and second electrodes 101′, 102′ can be interdigitated between third electrodes 103′, and vice versa. For example, electrode segments 101B′ and 102B′ are both located between electrode segments 103A′ and 103B′, and so forth. Similarly, electrode segment 103A′ is located between electrode segments 101A′ and 102B′, and so forth. As depicted in FIG. 4, the three interdigitated electrodes can comprise a repeating electrode segment pattern as follows: [[-101-103-102-101-103-102-]]; however any repeating segment pattern is possible and intended to fall within the scope of the disclosure.

Similar to the electrode assembly 100 depicted in FIG. 3A, the width of gap x1′ between first electrode 101′ segments, e.g., segments 101A-F′, can be similar to or different from the width of gap x1, the width of gap x2′ between second electrode 102′ segments, e.g., segments 102A-F′, can be similar to or different from the width of gap x2, and the width of gap x3′ between third electrode 103′ segments, e.g., segments 103A-F′, can be similar to or different from the width of gap x3. Adjacent electrode segments from different electrodes can also be separated by gaps having the same or different widths, such as the widths discussed above with respect to gaps a-d in FIG. 3A.

According to various embodiments, operation of the interdigitated electrode assembly 100′ can comprise: (1) applying drive voltage to the second and third interdigitated electrodes 102′, 103′, thereby creating partial coverage of the liquid crystal layer with horizontal liquid crystal directors, (2) applying drive voltage to the first and second interdigitated electrodes 101′, 102′, thereby adding to the partial coverage of the liquid crystal layer, and (3) applying drive voltage to the first and third interdigitated electrodes 101′, 103′, thereby completing full coverage of the liquid crystal layer with horizontal liquid crystal directors.

It should be noted that, while FIG. 4 is discussed in the context of a liquid crystal device that produces a bright state when powered off (no applied voltage, V=0) and dark state when powered on (V≠0), a device operating with the reverse configuration is also possible and intended to fall within the scope of the disclosure.

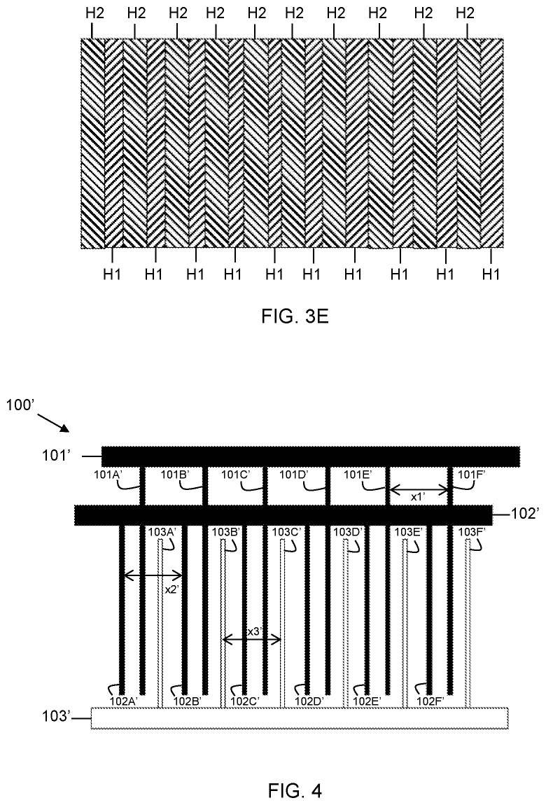

FIG. 5A illustrates a further embodiment of a multi-electrode design for a liquid crystal device with interdigitated electrodes. The interdigitated electrode assembly 100″ comprises four electrodes 101″, 102″, 103″, 104″. First electrode 101″ and fourth electrode 104″ can form a first interdigitated pair that can be connected to a first power supply (not shown) and second electrode 102″ and third electrode 103″ can form a second interdigitated pair that can be connected to a second power supply (not shown). Electrodes 101″ and 104″ can be coplanar in a first electrode layer and electrodes 102″ and 103″ can be coplanar in a second electrode layer, and these electrode layers can be separated by a barrier or passivation layer as depicted in FIGS. 6-7, discussed in more detail below. Other electrode layer orientations, electrode pairings, and/or power supply connections are also possible and intended to fall within the scope of the disclosure.

Referring again to FIG. 5A, the first interdigitated electrode pair comprising first and fourth electrodes 101″, 104″ can have a longer period. For example, the distance g between first electrode segment 101A″ and fourth electrode segment 104A″ can have a width ranging from about 25 μm to about 500 μm, from about 50 μm to about 250 μm, or from about 75 μm to about 150 μm, including all ranges and subranges therebetween. The second interdigitated electrode pair comprising second and third electrodes 102″, 103″ can have shorter or narrower period. For instance, the distance h between adjacent segments of second and third electrodes 102″, 103″, such as segments 102A″ and 103A″, can range from about 3 μm to about 100 μm, from about 10 μm to about 50 μm, or from about 20 μm to about 30 μm, including all ranges and subranges therebetween. A “period” as used herein is intended to refer to the combined width of one electrode and the gap between two neighboring electrodes.

Referring to FIG. 5B, a higher voltage can be applied to the first interdigitated electrode pair (first and fourth electrodes 101″, 104″) to create a large horizontal liquid crystal director region H3 that covers a majority of the liquid crystal cell. Once oriented, voltage can be applied to the second interdigitated electrode pair (second and third electrodes 102″, 103″) to energize them and keep the liquid crystal directors in a horizontal orientation. Voltage across the first interdigitated electrode pair may be reapplied occasionally if needed to help maintain the horizontal orientation.

### Liquid Crystal Devices

Embodiments of the disclosure will now be discussed with reference to FIGS. 6-7, which illustrate liquid crystal devices according to various aspects of the disclosure. The following general description is intended to provide an overview of the claimed devices, and various aspects will be more specifically discussed throughout the disclosure with reference to the non-limiting depicted embodiments, these embodiments being interchangeable with one another within the context of the disclosure.

FIGS. 6-7 illustrate cross-sectional views of non-limiting embodiments of liquid crystal devices 200, 200′. The liquid crystal devices disclosed herein may comprise a single liquid crystal layer, as depicted in FIG. 6, two liquid crystal layers, as depicted in FIG. 7, or more than two crystal liquid layers (not depicted).

Referring to FIG. 6, liquid crystal device 200 includes first substrate 201 having a first (outer) surface 201A and a second (interior) surface 201B and second substrate 202 having a first (interior) surface 202A and second (outer) surface 202B. First and second substrates 201, 202 define a first cell gap that can be filled with liquid crystal material and sealed, e.g., via seals s1, to form first liquid crystal layer 203. Alignment layers 204A-B may be present on opposing sides of the first liquid crystal layer 203, or one or both of the alignment layers may not be present depending on the device design. First interdigitated electrode assembly 205 is formed on and/or in direct contact with one of the interior surfaces of the substrates confining the first liquid crystal layer 203, i.e., second surface 201B of first substrate 201 (not illustrated) or first surface 202A of second substrate 202 (illustrated in FIG. 6). In the depicted embodiment, an applied electric field can travel from a high voltage interdigitated electrode on first surface 202A, loop through first liquid crystal layer 203, and end at a low voltage interdigitated electrode on surface 202A.

The first interdigitated electrode assembly 205 can comprise a first electrode layer 205A, which can comprise one or more interdigitated electrodes, such as a first pair of coplanar interdigitated electrodes or a single interdigitated electrode, and a second electrode layer 205B, which can also comprise one or more interdigitated electrodes, such as a second pair of coplanar interdigitated electrodes or a single interdigitated electrode. The first and second electrode layers 205A, 205B can be separated from each other by a barrier or passivation layer 205C, which can prevent physical contact between otherwise overlapping electrodes and preserve the integrity of the desired drive voltage cycle(s). First interdigitated electrode assembly 205 can thus comprise a multi-layered composite structure, the composite structure comprising at least three interdigitated electrodes.

The passivation layer can be, e.g., an insulating layer that prevents electrical short circuit between the two or more overlapping interdigitated electrodes. For instance, referring back to FIG. 5A, electrodes 103 and 104 overlap each other and should thus be electrically insulated from one another via a passivation layer. However, electrodes 102 and 103 do not overlap each other and thus do not need to be electrically insulated from one another using a passivation layer. While FIG. 6 illustrates two electrode layers separated by one passivation layer, it is also possible to have more than two electrode layers and more than one passivation layer, depending on the number of interdigitated electrodes in the first interdigitated electrode assembly 205 and their configuration.

Liquid crystal device 200 can be produced, in some embodiments, using the following exemplary process. If desired, an alignment layer 204A can be coated, printed, or otherwise deposited on the second surface 201B of the first substrate 201. Second electrode layer 205B, which can comprise at least one interdigitated electrode, can be coated, printed, or otherwise deposited on the first surface 202A of the second substrate 202, followed by patterning. A patterned interdigitated electrode or a pair of interdigitated electrodes can be manufactured from a single layer of electrode material using a process such as wet photolithography or dry photolithography and a first shadow mask. The barrier or passivation layer 205C can be deposited on the second electrode layer 205B using, e.g., chemical vapor deposition or plasma sputtering techniques. First electrode layer 205A can then be deposited on the passivation layer 205C and patterned using wet or dry photolithography and a second shadow mask. Although not illustrated, additional electrode layers and passivation layers can be deposited and patterned according to the above methods. If desired, an alignment layer 204B can be coated, printed, or otherwise deposited on the first interdigitated electrode assembly 205, e.g., on the first electrode layer 205A.

The substrates 201, 202 can be arranged, with their respective alignment and/or electrode layers facing each other to form a gap, which can be filled with liquid crystal material to form liquid crystal layer 203. In some embodiments, spacers (not illustrated) can be used to maintain the desired cell gap and resulting liquid crystal layer thickness. The liquid crystal material can be sealed in the cell gap around all edges using any suitable material, such as optically or thermally curable resins, to form first seal s1.

Referring to FIG. 7, liquid crystal device 200′ includes first substrate 201 having a first (outer) surface 201A and a second (interior) surface 201B, second substrate 202 having a first (interior) surface 202A and a second (outer) surface 202B, and third substrate 207 having a first (interior) surface 207A and a second (interior) surface 207B. First and third substrates 201, 207 define a first cell gap that can be filled with liquid crystal material and sealed, e.g., via seals s1, to form first liquid crystal layer 203. Second and third substrates 202, 207 define a second cell gap that can be filled with liquid crystal material and sealed, e.g., via seals s1, to form second liquid crystal layer 209. Alignment layers 204A-B and may be present on opposing sides of the first liquid crystal layer 203 and alignment layers 208A-B may be present on opposing sides of the second liquid crystal layer 209, or one or more of these alignment layers may not be present depending on the device design.

First interdigitated electrode assembly 205* is formed on and/or in direct contact with one of the interior surfaces of the substrates confining the first liquid crystal layer 203, i.e., second surface 201B of first substrate 201 (not illustrated) or first surface 207A of third substrate 207 (illustrated in FIG. 7). Similarly, second interdigitated electrode assembly 206* is formed on and/or in direct contact with one of the interior surfaces of the substrates confining the second liquid crystal layer 209, i.e., second surface 207B of third substrate 207 (illustrated in FIG. 7) or first surface 202A of second substrate 202 (not illustrated). As such, the location of the interdigitated electrode assemblies 205*, 206* may not be limited only to the surfaces of the interstitial (third) substrate 207 as depicted in FIG. 7. In some embodiments, the interdigitated electrode assemblies may alternatively be present on the interior surfaces 201B, 202A of the outer (first and second) substrates 201, 202. Furthermore, although not illustrated, interdigitated assemblies 205*, 206* can comprise multi-layered composite structures similar to the composite electrode structure 205 depicted in and discussed with respect to FIG. 6.

Liquid crystal device 200′ can be produced, in some embodiments, using the following exemplary process. If desired, an alignment layer 204A can be coated, printed, or otherwise deposited on the second surface 201B of the first substrate 201. Similarly, if desired, an alignment layer 208B can be coated, printed, or otherwise deposited on first surface 202A of second substrate 202. First and second interdigitated electrode assemblies 205*, 206* which can each comprise at least three interdigitated electrodes, can be deposited and patterned, including any passivation layer(s), on opposing surfaces 207A, 207B of the third substrate 207. If desired, alignment layers 204B and/or 208A can be coated, printed, or otherwise deposited on the first and second electrode assemblies 205*, 206*, respectively.

The substrates 201, 202, 207 can be arranged, with the third substrate 207 between the first and second substrates 201, 202 to form two gaps, which can be filled with liquid crystal material to form liquid crystal layers 203, 209. In some embodiments, spacers (not illustrated) can be used to maintain the desired cell gap and resulting liquid crystal layer thickness. The liquid crystal material can be sealed in the cell gaps around all edges using any suitable material, such as optically or thermally curable resins, to form first seal s1. A second seal s2 can optionally be applied to protect the exposed edges of the substrates and/or electrodes and/or any electrical connections within the device from mechanical impacts and exposure to liquids such as water or condensation.

It is to be understood that the scope of the disclosure is not limited solely to the liquid crystal devices depicted in FIGS. 6-7. The liquid crystal devices disclosed herein can comprise additional liquid crystal layers, substrates, alignment layers, electrode assemblies, electrode layers, and/or passivation layers, arranged in various different configurations. The liquid crystal devices disclosed herein can be used in various architectural and transportation applications. For example, the liquid crystal devices can be used as liquid crystal windows that can be included in doors, space partitions, skylights, and windows for buildings, automobiles, and other transportation vehicles such as trains, planes, boats, and the like.

A liquid crystal window may, in some embodiments, comprise an additional glass substrate, which is separated from the liquid crystal device by a gap. The additional glass substrate can comprise any suitable glass material having any desired thickness, including those discussed herein with respect to first and second substrates 201, 202. The gap can be sealed and filled with air, an inert gas, or a mixture thereof, which may improve the thermal performance of the liquid crystal window. Suitable inert glasses include, but are not limited to, argon, krypton, xenon, and combinations thereof. Mixtures of inert gases or mixtures of one or more inert gases with air can also be used. Exemplary non-limiting inert gas mixtures include 90/10 or 95/5 argon/air, 95/5 krypton/air, or 22/66/12 argon/krypton/air mixtures. Other ratios of inert gases or inert gases and air can also be used depending on the desired thermal performance and/or end use of the liquid crystal window.

In various embodiments, the additional glass substrate is an interior pane, e.g., facing the interior of the building or vehicle, although the opposite orientation, with glass facing the exterior, is also possible. Liquid crystal window devices for use in architectural applications can have any desired dimension including, but not limited to 2′×4′ (width×height), 3′×5′, 5′×8′, 6′×8′, 7×10′, 7′×12′. Larger and smaller liquid crystal windows are also envisioned and are intended to fall within the scope of this disclosure. Although not illustrated, it is to be understood that the liquid crystal device can comprise one or more additional components such as a frame or other structural component, a power source, and/or a control device or system.

### Materials

### Substrates

The liquid crystal devices and windows disclosed herein can comprise two or more substrates defining one or more liquid crystal layers. The first and second substrates may be referred to interchangeably herein as “outer” substrates. Similarly, the third substrate and any additional substrates, if present, may be referred to interchangeably herein as “interstitial” substrates.

According to non-limiting embodiments, at least one of the outer (e.g., first and second) substrates and/or interstitial (e.g., third) substrates, may comprise an optically transparent material. As used herein, the term “optically transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 95%, including all ranges and subranges therebetween. In certain embodiments, all of the substrates comprise an optically transparent material.

In non-limiting embodiments, the first and second substrates may comprise optically transparent glass sheets. According to other embodiments, the first and second substrates may comprise a material other than glass, such as plastics and ceramics, including glass ceramics. Suitable plastic materials include, but are not limited to, polycarbonates, polyacrylates such as polymethylmethacrylate (PMMA), and polyethyelenes such as polyethylene terephthalate (PET). The first and second substrates can have any shape and/or size, such as a rectangle, square, or any other suitable shape, including regular and irregular shapes and shapes with one or more curvilinear edges. According to various embodiments, the first and second substrates can have a thickness of less than or equal to about 4 mm, for example, ranging from about 0.1 mm to about 4 mm, from about 0.2 mm to about 3 mm, from about 0.3 mm to about 2 mm, from about 0.5 mm to about 1.5 mm, or from about 0.7 mm to about 1 mm, including all ranges and subranges therebetween. In certain embodiments, the first and second substrates can have a thickness of less than or equal to 0.5 mm, such as 0.4 mm, 0.3 mm, 0.2 mm, or 0.1 mm, including all ranges and subranges therebetween. In non-limiting embodiments, the substrates can have a thickness ranging from about 1 mm to about 3 mm, such as from about 1.5 to about 2 mm, including all ranges and subranges therebetween. The first and second substrates may, in some embodiments, comprise the same thickness, or may have different thicknesses.

The first and second substrates may comprise any glass known in the art, for example, soda-lime silicate, aluminosilicate, alkali-aluminosilicate, borosilicate, alkaliborosilicate, aluminoborosilicate, alkali-aluminoborosilicate, and other suitable display glasses. The first and second substrates may, in some embodiments, comprise the same glass, or may be different glasses. The first and second substrates may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

According to various embodiments, the first and second substrates may be chosen from glass sheets produced by a fusion draw process. Without wishing to be bound by theory, it is believed that the fusion draw process can provide glass sheets with a relatively low degree of waviness (or high degree of flatness), which may be beneficial for various liquid crystal applications. An exemplary glass substrate may thus, in certain embodiments, comprise a surface waviness of less than about 100 nm as measured with a contact profilometer, such as about 80 nm or less, about 50 nm or less, about 40 nm or less, or about 30 nm or less, including all ranges and subranges therebetween. An exemplary standard technique for measuring waviness (0.8-8 mm) with a contact profilometer is outlined in SEMI D15-1296 “FPD Glass Substrate Surface Waviness Measurement Method.”

The third substrate and any other interstitial substrates that might be present in the liquid crystal device, can comprise a glass material as discussed above with reference to first and second substrates. In some embodiments, the outer (e.g., first and second) substrates and the interstitial (e.g., third substrate) may all comprise a glass material, which can be the same or different glass materials. According to other embodiments, the interstitial substrates such as the third substrate may comprise a material other than glass, such as plastics and ceramics, including glass ceramics.

The third substrate and any other interstitial substrate that might be present in the liquid crystal device, can have any shape and/or size, such as a rectangle, square, or any other suitable shape, including regular and irregular shapes and shapes with one or more curvilinear edges. According to various embodiments, the third substrate can have a thickness of less than or equal to about 4 mm, for example, ranging from about 0.005 mm to about 4 mm, from about 0.01 mm to about 3 mm, from about 0.02 mm to about 2 mm, from about 0.05 mm to about 1.5 mm, from about 0.1 mm to about 1 mm, from about 0.2 mm to about 0.7 mm, or from about 0.3 mm to about 0.5 mm, including all ranges and subranges therebetween. In certain embodiments, the interstitial substrates can have a thickness of less than or equal to 0.5 mm, such as 0.4 mm, 0.3 mm, 0.2 mm, 0.1 mm, 0.05 mm, 0.02 mm, 0.01 mm, or less, including all ranges and subranges therebetween. If additional interstitial substrates are present, these substrates and the third substrate can comprise the same thickness, or may have different thicknesses.

According to further embodiments, the interstitial substrate(s) may comprise a highly conductive transparent material, for instance, a material having an electrical conductivity of at least about 10⁻⁵ S/m, at least about 10⁻⁴ S/m, at least about 10⁻³ S/m, at least about 10⁻² S/m, at least about 0.1 S/m, at least about 1 S/m, at least about 10 S/m, or at least about 100 S/m, e.g., ranging from 0.0001 S/m to about 1000 S/m, including all ranges and subranges therebetween.

### Alignment Layers

In some embodiments, the liquid crystal devices and windows disclosed herein can comprise one or more alignment layers. The individual alignment layers present in the liquid crystal devices may, in some embodiments, comprise the same or different materials, the same or different thicknesses, and the same or different orientations relative to one another. Alignment layers can comprise a thin film of material having a surface energy and anisotropy promoting the desired orientation for the liquid crystals in direct contact with its surface. Exemplary materials include, but are not limited to, main chain or side chain polyimides, which can be mechanically rubbed to generate layer anisotropy; photosensitive polymers, such as azobenzene-based compounds, which can be exposed to linearly polarized light to generate surface anisotropy; and inorganic thin films, such as silica, which can be deposited using thermal evaporating techniques to form periodic microstructures on the surface.

According to various embodiments, the alignment layers can have a thickness of less than or equal to about 100 nm, for example, ranging from about 1 nm to about 100 nm, from about 5 nm to about 90 nm, from about 10 nm to about 80 nm, from about 20 nm to about 70 nm, from about 30 nm to about 60 nm, or from about 40 nm to about 50 nm, including all ranges and subranges therebetween.

### Electrode Assemblies

The electrode assemblies disclosed herein and the liquid crystal devices and windows comprising them can include three or more interdigitated electrodes. The individual electrodes present in the liquid crystal devices may comprise the same or different materials, the same or different thicknesses, and the same or different patterns.

Interdigitated electrodes in the liquid crystal device may comprise one or more transparent conductive oxides (TCOs), such as indium tin oxide (ITO), indium zinc oxide (IZO), gallium zinc oxide (GZO), aluminum zinc oxide (AZO), and other like materials. Alternatively, the electrodes may comprise other transparent materials, such as a conductive mesh, e.g., comprising metals such as silver nanowires or other nanomaterials such as graphene or carbon nanotubes. Printable conductive ink layers such as ActiveGrid™ from C3Nano Inc. may also be used. According to various embodiments, the sheet resistance (e.g., as measured in ohms-per-square) of the electrodes can range from about 10 Ω/□ (ohms/square) to about 1000 Ω/□, such as from about 50 Ω/□ to about 900 Ω/□, from about 100 Ω/□ to about 800 Ω/□, from about 200 Ω/□ to about 700 Ω/□, from about 300 Ω/□ to about 600 Ω/□, or from about 400 Ω/□ to about 500 Ω/□, including all ranges and subranges therebetween.

The electrodes can, in some embodiments, be deposited on an interior surface of at least one substrate in the liquid crystal device, e.g., an interior surface of one or more of the outer (e.g., first and second) substrates, or on at least one opposing surface of the interstitial (e.g., third) substrates, if present. The thickness of each interdigitated electrode can, for example, independently range from about 1 nm to about 1000 nm such as from about 5 nm to about 500 nm, from about 10 nm to about 300 nm, from about 20 nm to about 200 nm, from about 30 nm to about 150 nm, or from about 50 nm to about 100 nm, including all ranges and subranges therebetween.

As discussed with respect to FIG. 6 above, the electrode assembly can comprise a multi-layer composition. For instance, interdigitated electrodes can be arranged to form electrode layers, which can comprise one or more electrodes each. Each individual electrode layer can have the same thickness as the interdigitated electrode(s) they comprise. Interdigitated electrode assemblies comprising three or more interdigitated electrodes can be formed from two or more electrode layers and at least one passivation layer. The thickness of the overall interdigitated electrode assembly can thus range from about 1 nm to about 1000 nm such as from about 10 nm to about 500 nm, from about 20 nm to about 400 nm, from about 30 nm to about 300 nm, from about 40 nm to about 200 nm, or from about 50 nm to about 100 nm, including all ranges and subranges therebetween.

A three-electrode assembly can comprise a first electrode layer including two interdigitated electrodes and a second electrode layer including one interdigitated electrode, which is separated from the first electrode layer by a passivation layer. Alternatively, the three-electrode assembly can include three electrode layers separated by two passivation layers. Similarly, a four-electrode assembly can comprise a first electrode layer including two interdigitated electrodes and a second electrode layer including two interdigitated electrodes, which is separated from the first electrode layer by a passivation layer. Other combinations of electrode layers, the interdigitated electrodes in such layers, and passivation layers are also possible and intended to fall within the scope of the disclosure.

A passivation layer can be applied between interdigitated electrodes that would otherwise overlap or contact one another when superimposed. The passivation layer can comprise any electrically insulative material, such as SiN or SiO₂. An exemplary thickness for the passivation layer can range from about 10 nm to about 1000 nm such as from about 20 nm to about 500 nm, from about 25 nm to about 400 nm, from about 30 nm to about 300 nm, from about 40 nm to about 200 nm, or from about 50 nm to about 100 nm, including all ranges and subranges therebetween.

### Liquid Crystal Layers

In additional embodiments, the liquid crystal devices and windows disclosed herein can comprise at least one liquid crystal layer disposed between at least two substrates, for example, one liquid crystal layer defined by two substrates, or two liquid crystal layers defined three substrates. The individual liquid crystal layers in the device may comprise the same or different liquid crystal materials and/or additives, the same or different thicknesses, the same or different switching modes, and the same or different orientations relative to one another.

A liquid crystal layer can comprise liquid crystals and one or more additional components, such as dyes or other coloring agents, chiral dopants, polymerizable reactive monomers, photoinitiators, polymerized structures, or any combination thereof. The liquid crystals can have any liquid crystal phase, such as achiral nematic liquid crystal (NLC), chiral nematic liquid crystal, cholesteric liquid crystal (CLC), or smectic liquid crystal, which are operable over a broad range of temperatures, such as from about −40° C. to about 110° C.

According to various embodiments, the liquid crystal layers can comprise a cell gap or cavity that is filled with liquid crystal material. The thickness of the liquid crystal layer, or the cell gap distance, can be maintained by particle spacers and/or columnar spacers dispersed in the liquid crystal layer. The liquid crystal layers can have a thickness of less than or equal to about 0.2 mm, for example, ranging from about 0.001 mm to about 0.1 mm, from about 0.002 mm to about 0.05 mm, from about 0.003 mm to about 0.04 mm, from about 0.004 mm to about 0.03 mm, from about 0.005 mm to about 0.02 mm, or from about 0.01 mm to about 0.015 mm, including all ranges and subranges therebetween. The individual liquid crystal layers in the device may all comprise the same thickness, or may have different thicknesses.

The substrates in the liquid crystal device can have a surface energy promoting the desired alignment of the liquid crystal director in a ground or “off” state without applied voltage. A vertical or homeotropic alignment is achieved when the liquid crystal director has a perpendicular or substantially perpendicular orientation with respect to the plane of the substrate. A planar or homogeneous alignment is achieved when the liquid crystal director has a parallel or substantially parallel orientation with respect to the plane of the substrate. An oblique alignment is achieved when the liquid crystal direction has a large angle with respect to the plane of the substrate, which is substantially different from planar or homeotropic, i.e., ranging from about 20° to about 70°, such as from about 30° to about 60°, or from about 40° to about 50°, including all ranges and subranges therebetween.

In some embodiments, dyes or other coloring agents, such as dichroic dyes, can be added to one or more of the liquid crystal layers to absorb light transmitted through the liquid crystal layer(s). Dichroic dyes typically absorb light more strongly along a direction parallel to the direction of a transition dipole moment in the dye molecule, which is typically the longer molecular axis of the dye molecule. Dye molecules oriented with their long axis perpendicular to the direction of light polarization will provide low light attenuation, whereas dye molecules oriented with their long axis parallel to the direction of light polarization will provide strong light attenuation.

Generally, liquid crystal devices function in a haze-free or low-haze fashion such that an observer can see through the liquid crystal device with little to no distortion. However, in certain instances, it may be desirable to provide the liquid crystal device with a “privacy” mode such that the image an observer can see through the liquid crystal device is darkened or diffused. Such a privacy mode can be achieved, e.g., by providing a light scattering effect to trap light within the liquid crystal layer such that the amount of light absorbed by the dye is increased.

Light scattering effects within the liquid crystal layer can be achieved in several different ways that promote or enhance the random alignment of liquid crystals. One or more chiral dopants may be added to the liquid crystal mixture to form highly twisted cholesteric liquid crystals (CLC), which may have a random alignment that provides light scattering effects, referred to herein as a focal conic texture. Random liquid crystal alignment can also be promoted or assisted by including polymer structures, such as polymer fibers, in the matrix of the liquid crystal layer, referred to herein as polymer stabilized cholesteric texture (PSCT). Random liquid crystal alignment can also be achieved using small droplets of nematic liquid crystal (without a chiral dopant) randomly dispersed in a solid polymer layer or a dense network of polymer fibers, or polymer walls, referred to herein as polymer dispersed liquid crystal (PDLC).

According to various embodiments, polymers may be dispersed in the matrix of the liquid crystal layer or on the interior surfaces of the glass and interstitial substrates. Such polymers may be formed by polymerization of monomers dissolved in the liquid crystal mixture. In certain embodiments, polymer protrusions or other polymerized structures may be formed on the interior surfaces of the outer substrates and/or interstitial substrates, such as in a normally clear liquid crystal device with homeotropic alignment layer(s), to define an azimuthal switching direction and to improve electro-optic switching speed.

As noted above, chiral dopants may be added to the liquid crystal mixture to achieve a twisted supramolecular structure of liquid crystal molecules, referred to herein as cholesteric liquid crystal (CLC). The amount of twist in the CLC is described by a helical pitch which represents the rotation angle of a local liquid crystal director by 360 degrees across the cell gap thickness. CLC twist can also be quantified by a ratio (d/p) of cell gap thickness (d) to CLC helical pitch (p). For liquid crystal applications, the amount of chiral dopant dissolved in the liquid crystal mixture can be controlled to achieve a desired amount of twist across a given cell gap distance. It is within the ability of one skilled in the art to select the appropriate dopant and its amount to achieve the desired twisted effect.

In various embodiments, the liquid crystal layers disclosed herein may have an amount of twist ranging from about 0° to about 25×360° (or d/p ranging from about 0 to about 25.0), for example, ranging from about 45° to about 1080° (d/p from about 0.125 to about 3), from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. As used herein, a liquid crystal mixture that does not include chiral dopants is referred to as a nematic liquid crystal (NLC). A liquid crystal that includes a chiral dopant and has a small pitch and a large twist refers to a CLC mixture wherein d/p is greater than 1. A liquid crystal that includes a chiral dopant and has a large pitch and a small twist refers to a CLC mixture wherein d/p is less than or equal to 1.

Liquid crystal layers having a twisted supramolecular structure can be useful for reducing or eliminating dead zones in the liquid crystal device and/or for providing polarization independent performance, e.g., the ability to attenuate unpolarized light. For example, in the case of CLC in a liquid crystal device with interdigitated electrodes and homeotropic alignment, the amount of chiral dopant can be chosen to achieve a twist ranging from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. In the powered off state, the twisted supramolecular liquid crystal structure will be suppressed by the alignment layers, leading to vertical alignment of the liquid crystal molecules, which allows for maximum transmission of light. In the powered on state, the liquid crystal director in the bulk of the liquid crystal layer will be realigned along the applied electric field, creating a dark state with strong attenuation of the transmitted light. In the dark state, a small fraction of the liquid crystal molecules near the substrate surfaces can remain in the original vertical orientation, but the majority of the liquid crystal molecules will have the liquid crystal director switched to the horizontal orientation. Some of the spontaneous twist from the CLC can propagate into the inactive regions or dead zones above the electrodes, thereby making these regions smaller.

Another way to reduce or eliminate dead zones or inactive spaces between electrodes is to define an azimuthal orientation of the liquid crystal molecules that is other than 90° with respect to the electrode lines (or other than parallel with respect to the electric field lines). For example, the azimuthal orientation of the liquid crystal molecules with respect to the electrode lines can range from about 89° to about 45°, such as from about 3° to about 15°, or from about 5° to about 10°, including all ranges therebetween.

Polarization independent performance, e.g., the ability to attenuate unpolarized light, can be challenging in a single cell liquid crystal device such as device 200 illustrated in FIG. 6. The challenge is to have both linear polarizations of light incident on the device transmitted with equal low loss in the bright state and equal high attenuation in the dark state. This can be difficult in a single cell liquid crystal device with interdigitated electrodes because the electric field is parallel to the substrates. If the liquid crystal molecules are in a planar orientation in the powered off state, then the liquid crystal molecules will be oriented in a horizontal state in the powered on state. Light polarized parallel to this direction will be strongly attenuated, but light polarized orthogonal to this direction will not. If only one of the two light polarizations is transmitted or attenuated, the contrast ratio will be negatively impacted.

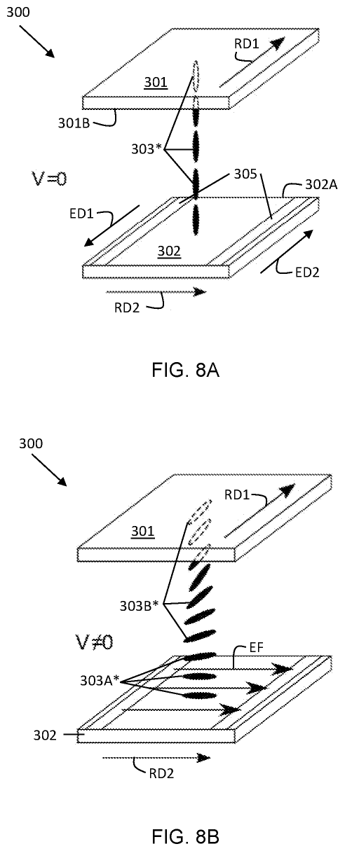

Polarization independent performance can be achieved in a single cell liquid crystal device with coplanar electrodes by using a liquid crystal material with a twisted supramolecular structure, such as CLC with a vertical or homeotropic orientation in the powered off state. FIG. 8A illustrates an exploded view of a liquid crystal device 300 in the off state (V=0). The exploded view is simplified to illustrate only first substrate 301, liquid crystal molecules 303*, interdigitated electrode assembly 305, and second substrate 302. In the powered off state (V=0), as illustrated in FIG. 8A, the liquid crystal molecules 303* are aligned vertically to create a bright state with high light transmission. First substrate 301 comprises an alignment layer (not illustrated) on interior (second) surface 301B, which is rubbed in a first direction represented by arrow RD1. Second substrate 302 comprises an alignment layer (not illustrated) on interior (first) surface 302A, which is rubbed in a second direction represented by arrow RD2. Directions RD1 and RD2 are orthogonal to each other. Direction RD2 is also orthogonal to the directions ED1, ED2 in which the interdigitated electrode segments of assembly 305 extend toward each other on the surface 302A of substrate 302. Direction RD2 is also approximately parallel to the electric field EF lines created when voltage is applied to device 300, as shown in FIG. 8B.

In the powered on state (V≠0), as illustrated in FIG. 8B, the horizontal electrical field EF realigns the liquid crystal molecules 303A* proximate the electrode assembly 305 into a horizontal orientation. However, liquid crystal molecules 303B* further away from the electrode assembly 305 will feel a weaker dielectric torque, i.e., will not be as strongly affected by the applied electric field EF. The orientation of liquid crystal molecules 303B* will relax towards the first rubbing direction RDI of the alignment layer (not shown) on first substrate 301. In the powered on state, the liquid crystal layer will undergo a 90° twist from the alignment layer on the second substrate 302 to the orthogonally rubbed alignment layer on the first substrate 301. Unpolarized light incident on the liquid crystal layer will thus have both polarizations equally attenuated due to the distribution of liquid crystal molecules (and any associated dye molecules) in all lateral directions. Cell gap width, electrode segment width, and or electrode segment gap width can each be chosen, in some embodiments, such that liquid crystal layer region proximate the second substrate 302 (bottom half) is reoriented by the applied electric field EF, whereas the liquid crystal layer region proximate the first substrate 301 (top half) is able to relax toward the azimuthal orientation of the rubbing direction RD1 of the alignment layer on the first substrate 301.

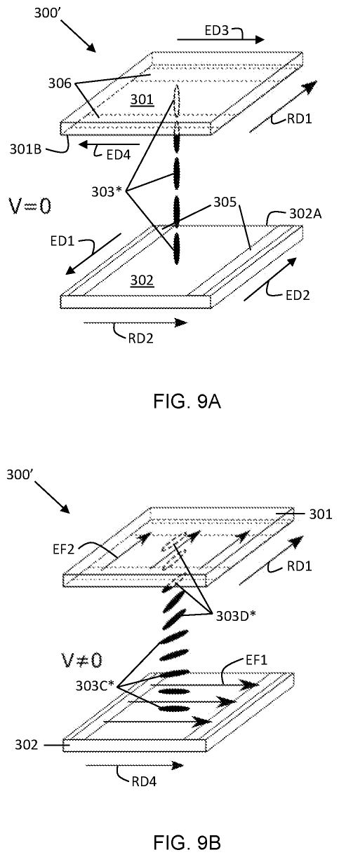

Polarization independent performance can also be achieved in a single cell twisted liquid crystal device by patterning interdigitated electrodes with orthogonal orientations on both interior surfaces of the substrates defining the liquid crystal layer. FIG. 9A illustrates an exploded view of a liquid crystal device 300′ in the off state (V=0). The exploded view is simplified to illustrate only first substrate 301, liquid crystal molecules 303*, first interdigitated electrode assembly 305, second interdigitated electrode assembly 306, and second substrate 302. In the powered off state (V=0), as illustrated in FIG. 9A, the liquid crystal molecules 303* are aligned vertically to create a bright state with high light transmission. First substrate 301 comprises an alignment layer (not illustrated) on interior (second) surface 301B, which is rubbed in a first direction represented by arrow RD1. Second substrate 302 comprises an alignment layer (not illustrated) on interior (first) surface 302A, which is rubbed in a second direction represented by arrow RD2.

Directions RD1 and RD2 are orthogonal to each other. Directions ED1, ED2, the directions in which the interdigitated electrode segments of first assembly 305 extend toward each other on surface 302A of second substrate 302, are orthogonal to directions ED3, ED4, the directions in which the interdigitated electrode segments of second assembly 306 extend toward each other on surface 301B of first substrate 301. Direction RD1 is orthogonal to directions ED3, ED4 and direction RD2 is orthogonal to directions ED1, ED2. Direction RD1 is also parallel to second electric field EF2 lines created across second assembly 306 when voltage is applied to device 300′, as shown in FIG. 9B. Similarly, direction RD2 is parallel to the first electric field EF1 lines created across first assembly 305 when voltage is applied to device 300′, as shown in FIG. 9B.

In the powered on state (V≠0), as illustrated in FIG. 9B, the first horizontal electrical field EF1 realigns the liquid crystal molecules 303C* proximate the first electrode assembly 305 into a horizontal orientation. The second horizontal electric field EF2 realigns the liquid crystal molecules 303D* proximate the second electrode assembly 306. In the powered on state, the orthogonal electric fields EF1, EF2 will cause the liquid crystal layer to undergo a 90° twist from the second substrate 302 to the first substrate 301. Unpolarized light incident on the liquid crystal layer will thus have both polarizations equally attenuated due to the distribution of liquid crystal molecules (and any associated dye molecules) in all lateral directions. It should be noted that a thin layer of liquid crystal molecules on each interior surface of substrates 301, 302 may not be rotated by the electric field due to the strong influence of the directly adjacent alignment layers. As such, these thin layers may still be oriented in the vertical direction and light attenuation may be slightly reduced. However, even in this scenario, the two light polarizations will still experience the same amount of attenuation because the layer of liquid crystal molecules adjacent first substrate 301 will have a perpendicular orientation relative to the layer of liquid crystal molecules adjacent second substrate 302.

It should be noted that, while FIGS. 8-9 are discussed in the context of a liquid crystal device that produces a bright state when powered off (no applied voltage, V=0) and dark state when powered on (V≠0), a device operating with the reverse configuration is also possible and intended to fall within the scope of the disclosure.

Polarization independent performance can also be achieved with nematic (untwisted) liquid crystal by using a liquid crystal device comprising two liquid crystal layers, such as device 200′ illustrated in FIG. 7. As discussed above, liquid crystal layers can comprise a dichroic dye material that strongly absorbs light with polarization direction parallel to the direction of a transitional dipole moment in dye molecule (typically oriented along the long axis of a molecule). Therefore, a nematic liquid crystal layer containing such dichroic dyes will work most effectively for only one linear polarization of light. In the device 200′ illustrated in FIG. 7, the two liquid crystal layers 203, 209 can be arranged such that the interdigitated electrode patterns associated with each layer are orthogonal with respect to one another to provide a crossed orientation allowing for the attenuation of unpolarized light. The alignment layers 204A-B associated with the first liquid crystal layer 203 and the alignment layers 208A-B associated with the second liquid crystal layer 209 can also be rubbed in directions orthogonal to each other to provide a crossed orientation allowing for the attenuation of unpolarized light.

Of course, a twisted liquid crystal material can also be used in device 200′ of FIG. 7, which can amplify the optical effect of the twisted supramolecular structure. The alignment layers in such a twisted dual-layer liquid crystal device, if present, can be rubbed in various directions with respect to each other, including parallel, antiparallel, orthogonal, or at any angle other than 90°.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A liquid crystal device comprising:
(a) a first substrate comprising an outer surface and an interior surface;
(b) a second substrate comprising an outer surface and an interior surface;
(c) a liquid crystal layer comprising a first surface and a second surface; wherein the liquid crystal layer is disposed between the first substrate and the second substrate; and
(d) an electrode assembly comprising at least three interdigitated electrodes, wherein the electrode assembly is disposed on the interior surface of the first substrate.

2. The liquid crystal device of claim 1, wherein the first and second substrates are glass substrates.

3. The liquid crystal device of claim 1, wherein the interdigitated electrodes comprise at least one transparent conductive layer.

4. The liquid crystal device of claim 1, wherein the electrode assembly comprises three interdigitated electrodes.

5. The liquid crystal device of claim 4, wherein the electrode assembly comprises:
(i) a first electrode layer comprising a first interdigitated electrode and a second interdigitated electrode;
(ii) a second electrode layer comprising a third interdigitated electrode; and
(iii) a passivation layer disposed between the first and second electrode layers.

6. The liquid crystal device of claim 5, wherein the passivation layer comprises SiN or SiO₂.

7. The liquid crystal device of claim 1, wherein the electrode assembly comprises four interdigitated electrodes.

8. The liquid crystal device of claim 7, wherein the electrode assembly comprises:
(i) a first electrode layer comprising a first interdigitated electrode and a second interdigitated electrode;
(ii) a second electrode layer comprising a third interdigitated electrode and a fourth interdigitated electrode; and
(iii) a passivation layer disposed between the first and second electrode layers.

9. The liquid crystal device of claim 8, wherein the passivation layer comprises SiN or SiO₂.

10. The liquid crystal device of claim 7, wherein the electrode assembly comprises a first pair of interdigitated electrodes having a first period and a second pair of interdigitated electrodes having a second period, and wherein the first period is longer than the second period.

11. The liquid crystal device of claim 1, further comprising at least one alignment layer in direct contact with the first or second surface of the liquid crystal layer.

12. The liquid crystal device of claim 11, comprising a first alignment layer in direct contact with the first surface of the liquid crystal layer and a second alignment layer in direct contact with the second surface of the liquid crystal layer.

13. The liquid crystal device of claim 1, wherein the liquid crystal layer further comprises at least one additional component chosen from dyes, coloring agents, chiral dopants, polymerizable reactive monomers, photoinitiators, and polymerized structures.

14. The liquid crystal device of claim 1, wherein the liquid crystal layer comprises a twisted supramolecular structure.

15. The liquid crystal device of claim 14, further comprising a first alignment layer in direct contact with the first surface of the liquid crystal layer and a second alignment layer in direct contact with the second surface of the liquid crystal layer.

16. The liquid crystal device of claim 15, wherein the first alignment layer has a first rubbing direction and the second alignment layer has a second rubbing direction, and wherein the first and second rubbing directions are orthogonal to one another.

17. The liquid crystal device of claim 15, further comprising a second electrode assembly disposed on the interior surface of the second substrate, wherein the first electrode assembly comprises a first electrode direction and the second electrode assembly comprises a second electrode direction, and wherein the first electrode direction and the second electrode direction are orthogonal to one another.

18. The liquid crystal device of claim 17, wherein the first alignment layer has a first rubbing direction orthogonal to the first electrode direction, and wherein the second alignment layer has a second rubbing direction orthogonal to the second electrode direction.

19. A liquid crystal window comprising:
(a) the liquid crystal device of claim 1; and
(b) a glass substrate separated from the liquid crystal device by a sealed gap.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
